(19) United States
(12) Patent Application Publication
(10) Pub. No.: US 2004/0163900 A1
(43) Pub. Date: Aug. 26, 2004

(54) Motor-actuable disc brake

(76) Inventors: Christoph Beuerle, Koblenz (DE); Ulrich Danne, Bendorf (DE); Leo Gilles, Koblenz (DE)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/785,112

(22) Filed: Feb. 24, 2004

Related U.S. Application Data
(63) Continuation of application No. PCT/EP02/09562, filed on Aug. 27, 2002.

(30) Foreign Application Priority Data
Aug. 31, 2001 (DE) 101 42 644.5

(51) Int. Cl. F16D 55/08

(52) U.S. Cl. 188/72.1; 188/156

(57) ABSTRACT

A disc brake 10 is described. The disc brake 10 comprises two brake shoes 16, 18, which for generating a clamping force are pressable against both sides of a brake disc 20, a conversion device 42, which is connectable to a motor 30 and which converts a driving motion of the motor 30 into an actuating motion for actuating at least one of the two brake shoes 16, 18, as well as a support device 62 for taking up a reaction force, which upon generation of the clamping force is introduced into the conversion device 42. Between the conversion device 42 and the support device 62 at least one force sensor is disposed for measuring at least a fraction of the reaction force. The at least one force sensor may have a planar form of construction.

The invention relates to a disc brake comprising two brake shoes, which for generating a clamping force are pressable against both sides of a brake disc, a conversion device, which is connectable to a motor and which converts a driving motion of the motor into an actuating motion for actuating at least one of the brake shoes, and a support device for taking up a reaction force, which upon generation of the clamping force is introduced into the conversion device.

Such a disc brake is known from WO88/04741. The forces arising in said disc brake during a braking operation may be subdivided into a clamping force (also known as axial force, transverse force or normal force) and a peripheral force (also known as frictional force). The component of force introduced by a brake shoe into the brake disc at right angles to the plane of the brake disc is described as clamping force. By peripheral force, on the other hand, is meant the component of force, which on account of the brake friction between a friction lining of the brake shoe and the brake disc acts in peripheral direction of the brake disc upon the brake shoe. By multiplying the peripheral force by the distance of the application point of the peripheral force from the axis of rotation of the wheels, the braking torque may be determined.

In the disc brake known from WO88/04741 the clamping force is generated by an electric motor. The rotational motion of a motor shaft is first geared down by means of a planetary gear and then converted by means of a conversion device in the form of a nut/spindle arrangement into a translational motion. A piston disposed functionally downstream of the conversion device transmits the translational motion to one of the two brake shoes. As the disc brake is designed as a floating-caliper disc brake, in a known manner the brake shoe, which does not directly interact with the piston, is also pressed against the brake disc.

Modern brake systems, for open- and closed-loop control purposes, require an exact acquisition of the forces arising during a braking operation. It is therefore customary to equip disc brakes with one or more force sensors and to couple these force sensors to open- and closed-loop control circuits.

The underlying object of the invention is to indicate a disc brake, which is of a design optimized for open- and closed-loop control purposes.

Proceeding from a disc brake of the initially described type, this object is achieved according to the invention in that between the conversion device and the support device at least one force sensor, which preferably has a planar form of construction, is disposed for acquiring at least a fraction of the reaction force. The arrangement according to the invention of the at least one force sensor is advantageous in that the clamping force is determined exactly and in a manner at least extensively decoupled from the peripheral force. Furthermore, the at least one force sensor is not subject to the high temperatures in the region of the brake shoes.

In accordance with the aspect of the planar form of construction, the dimension of the force sensor along the axis, along which the reaction force acts upon the force sensor, is smaller than the dimensions of the force sensor at right angles to said axis. Such requirements are met typically by force sensors of a sandwich style of construction. The force sensor may therefore have e.g. a planar substrate as well as a piezoresistive layer applied onto the planar substrate. The piezoresistive layer is advantageously manufactured by means of an epitaxial technique and applied e.g. by means of bonding onto the planar substrate. According to the invention, however, piezo force sensors of a different design as well as force sensors based on different physical principles of measurement may also be used.

According to a preferred development of the invention, the disc brake comprises a plurality of force sensors, which are arranged distributed in such a way that an averaged acquisition of the reaction force may be effected. Because of the high forces arising during a braking operation and the resultant deformation of individual components of the disc brake, e.g. of a caliper, the reaction force is namely introduced, as a rule, non-symmetrically into the support device. If the reaction force introduced into the support device is then measured at a plurality of positions spaced apart from one another, it is possible to generate a plurality of measured values, which allow an exact conclusion about the actually arising clamping force. In the simplest case, the conclusion about the actually arising clamping force is effected by taking the mean of the individual, measured reaction force values.

For acquiring the reaction force at different positions two or more force sensors may be provided, which are spaced apart from one another and disposed in a plane at right angles to a longitudinal axis of the disc brake. Such a coplanar arrangement of planar force sensors allows a particularly simple determination of the actually arising clamping force. Preferably, the disc brake comprises at least four force sensors, which are disposed in such a way that two force sensors, which in relation to the longitudinal axis of the disc brake are adjacent in peripheral direction, have an angular distance in the order of magnitude of 90° or less in relation to said longitudinal axis.

The support device for taking up the reaction force is expediently coupled rigidly to a housing of the disc brake. The support device may therefore be e.g. a separate component fastened inside the housing of the disc brake. It is however also conceivable to design the support device e.g. in the form of a step integrally with the housing of the disc brake. In said case, the at least one force sensor may be applied onto the step or integrated in whole or in part into the step.

The at least one force sensor may however also be disposed on or in a separate force sensor carrier. This carrier, which may have an annular shape, is expediently disposed between the conversion device and the support device.

In addition to or instead of the carrier, a bearing for the conversion device may be disposed between the conversion device and the support device. When a bearing is provided for the conversion device, the at least one force sensor may also be disposed in the region of this bearing. It is therefore conceivable to fasten the force sensor in or on a component of the bearing.

According to a preferred development of the invention, the conversion device is designed in such a way that it converts a rotary driving motion of the motor into a translatory actuating motion for actuating at least one of the brake shoes. In said case the support device may interact, optionally via a bearing, with a component of the conversion device that is settable in rotational motion. When the conversion device comprises e.g. a nut/spindle arrangement, the support device may interact with a rotating nut (in the case of a spindle movable in a translatory manner) or with a rotating spindle (in the case of a nut movable in a translatory manner). The spindle of the nut/spindle arrangement is preferably settable in rotational motion and supported relative to the reaction force against a step of the disc brake housing.

The invention has many possible areas of application. The advantages according to the invention come into play in a particularly pronounced manner in an electromotive vehicle brake system equipped with the disc brake according to the invention.

Several embodiments of a disc brake according to the invention are described in detail below with reference to the accompanying diagrammatic drawings. The drawings show:

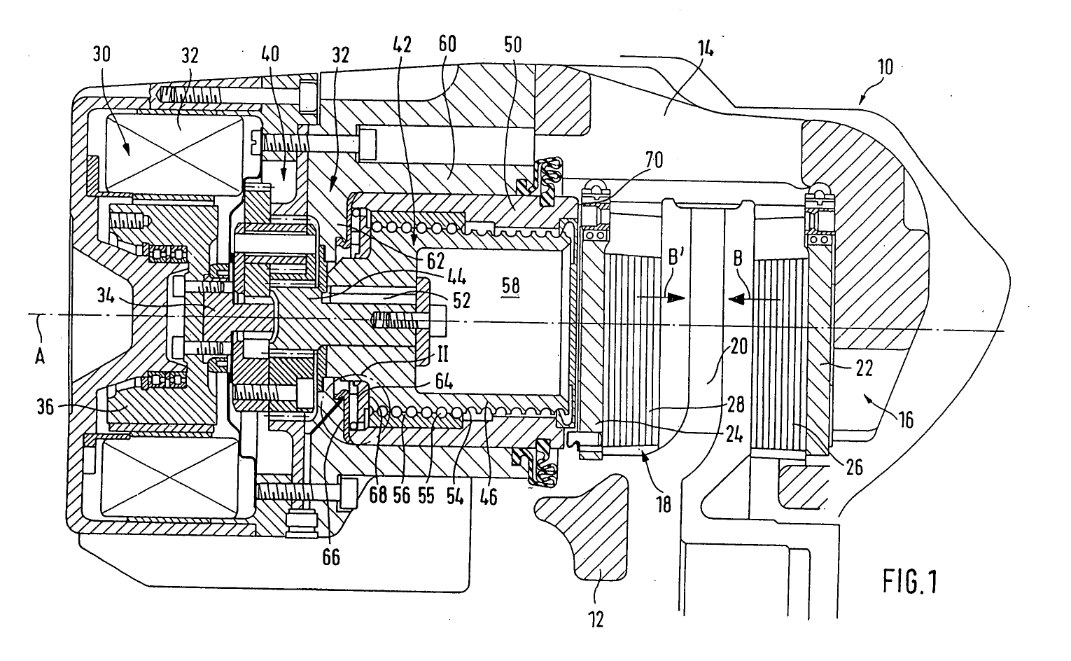

FIG. 1 a sectional view of a disc brake according to the invention;

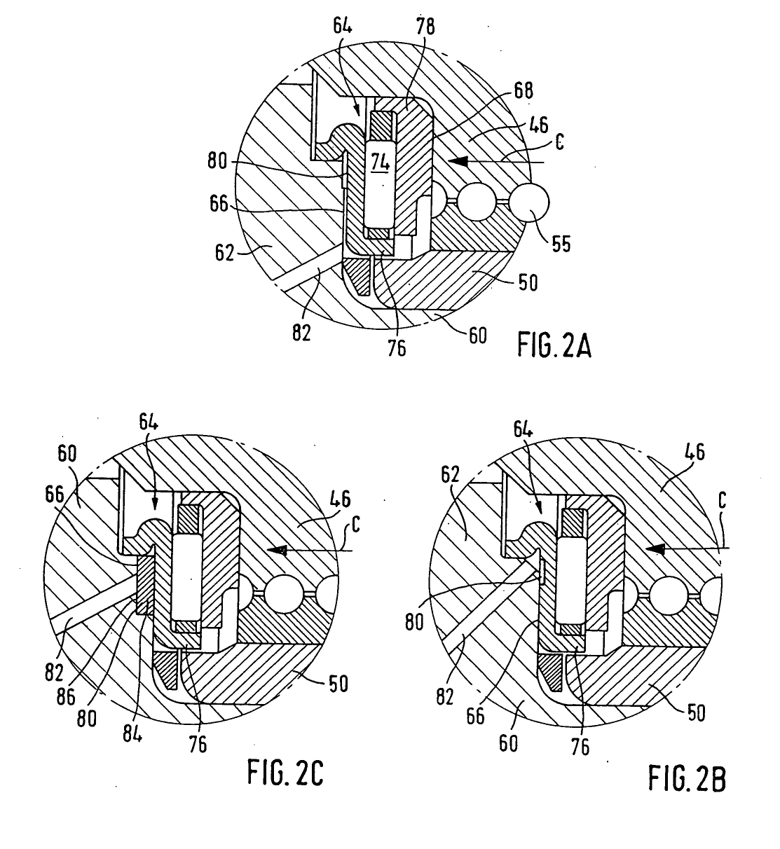

FIGS. 2A-2C in each case an enlarged detail of the disc brake according to FIG. 1 with a force sensor disposed at different points;

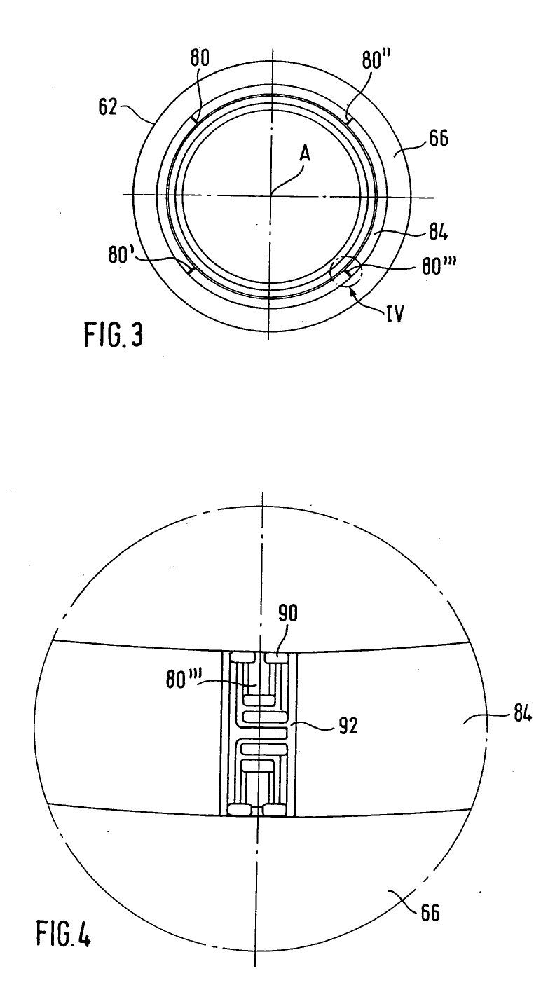

FIG. 3 a plan view of a support device with assembled carrier ring for four force sensors according to FIG. 2C; and

FIG. 4 an enlarged detail of the support device according to FIG. 3.

FIG. 1 shows an embodiment of a floating-caliper disc brake 10 according to the invention having a floating caliper 14, which is displaceable relative to a brake anchor plate 12. The disc brake 10 comprises two brake discs 16, 18, which are pressable against both sides of a brake disc 20. Each of the two brake shoes 16, 18 has a carrier plate 22, 24 and a friction lining 26, 28 disposed on the carrier plate 22, 24. By means of the friction lining 26, 28 each of the two brake shoes 16, 18 interacts with the brake disc 20. During the interaction of the brake shoes 16, 18 with the brake disc 20 a clamping force acting along the arrows B, B′ is generated.

For generating the clamping force an electric motor 30 is provided, which comprises a motor winding 32 and a rotor 36, which is coupled rigidly to a motor shaft 34. The motor shaft 34 is connected to the input side of a step-down gearing 40, the output side of which is coupled to a conversion device 42 for converting a rotational motion of the electric motor 30 into a translational motion. The conversion device 42 is designed as a spindle/nut arrangement and comprises a two-part spindle unit 44, 46 as well as a nut 50 disposed coaxially with and radially outside of the spindle unit 44, 46. The two-part spindle unit is composed of a first, rod-shaped spindle element 44 and a second cup-shaped spindle element 46 coupled non-rotatably to the rod-shaped spindle element 44. The spindle unit 44, 46 may alternatively be formed by a single component. In said case, the rod-shaped spindle element 44 and the cup-shaped spindle element 46 are of an integral design.

The rod-shaped spindle element 44 is coupled by its end remote from the brake shoes 16, 18 to the output end of the step-down gearing 40 and projects with its other end into a cylindrical opening 52 in the base of the cup-shaped spindle element 46. The non-rotatable connection between the two spindle elements 44, 46 is guaranteed by means of the engagement of ribs of the cup-shaped spindle element 46, which are formed in the region of the opening 52, into corresponding grooves of the rod-shaped spindle element 44.

In a departure from FIG. 1, the spindle element 44 of the conversion device 42 may alternatively be coupled by means of a curved-tooth system to the step-down gearing 40 and/or the electric motor 30. By virtue of the curved-tooth system there is therefore not only a non-rotatable connection, but the spindle element 44 is movable about the longitudinal axis A within a specific angular range, so that transverse forces are compensated, which arise during the rotational motion of the spindle unit 44, 46 and may adversely influence the determination of the actual clamping force.

The conversion device 42 is designed in such a way that a rotation of the spindle unit 44, 46 about a longitudinal axis A of the disc brake 10 is converted into a translational movement of the nut 50 along said longitudinal axis A. For this purpose, the cup-shaped spindle element 46 is provided with an external thread 54, which by means of a plurality of ball elements 55 interacts with a complementary internal thread 56 of the nut 50.

The conversion device 42 is accommodated in a central opening 58 of a housing 60 of the disc brake 10. The opening 58 is delimited by a reduction of the inside diameter of the housing 60 in the form of a step 62. As is explained in detail further below, the step 62 functions as a support device for taking up a reaction force, which is introduced into the conversion device 42.

A multi-component bearing 64 is disposed between an end face of the step 62 facing the brake shoes 16, 18 and an end face 68 of the cup-shaped spindle element 46 facing the electric motor 30. The bearing 64 guarantees a stabilizing of the rotational movement of the spindle unit 44, 46 particularly when a reactive force is introduced into the spindle unit 44, 46.

There now follows a detailed description of the mode of operation of the disc brake 10 illustrated in FIG. 1.

If, starting from the inoperative position of the disc brake 10 illustrated in FIG. 1, the electric motor 30 is set in operation to generate a clamping force, the step-down thread 40 transmits a rotational motion of the motor shaft 34 to the spindle unit 44, 46. The direction of rotation of the spindle unit 44, 46 is selected in such a way that the nut 50 interacting with the spindle unit 44, 46 is moved in FIG. 1 to the right. In said case, the end face 70 of the nut 50 facing the brake shoes 16, 18 moves into abutment with the surface of the carrier plate 24 of the brake shoe 18 remote from the friction lining 28. The brake shoe 18 is then grasped by the translational motion of the nut 50 and pressed in the direction of the arrow B′ against the brake disc 20. Because of the structural design of the disc brake 10 as a floating caliper disc brake, as a result of the pressing of the brake shoe 18 against the brake disc 20 the opposite brake shoe 16 is also pressed in the direction of the arrow B against the brake disc 20. In said manner, the clamping force acting in the direction of the arrows B, B′ is generated.

In accordance with the basic principle of physics, actio=reactio, upon generation of the clamping force a reaction force acts upon the nut 50 and is introduced by the nut 50 into the cup-shaped spindle element 46 and by the cup-shaped spindle element 46 via the bearing 64 into the step 62 functioning as a support device, i.e. into the housing 60 of the disc brake 10.

In order to discontinue or reduce the clamping force, the electric motor 30 is controlled in such a way that the motor shaft 34 and hence also the spindle unit 44, 46 changes its direction of rotation. As a result of the reversal of the direction of rotation, the nut 50 is moved in FIG. 1 to the left, thereby reducing the clamping force generated by the brake shoes 16, 18.

In FIG. 2A a detail enlargement II of the disc brake 10 according to FIG. 1 is illustrated. The detail enlargement shows the construction of the bearing 64, which is disposed between an end face 66 of the step 62 and an opposite end face 68 of the cup-shaped spindle element 46. The bearing 64 comprises a plurality of rollers 74, which are disposed between two annular mountings 76, 78. The first mounting 76 has a substantially Z-shaped cross section and lies against the end face 66 of the step 62. The second mounting 78 has a substantially L-shaped cross section and lies against the end face 68 of the cup-shaped spindle element 46. The rollers 74 are held captive between the two mountings 76, 78.

A planar force sensor 80 is integrated into the end face 66 of the step 62, i.e. into the housing 60 of the disc brake 10, and therefore disposed functionally between the step 62 acting as a support device and the cup-shaped spindle unit 46 of the conversion device. A reaction force, which is introduced by the cup-shaped spindle element 46 via its end face 68 in the direction of the arrow C into the bearing 64, is transmitted by an end face of the mounting 76 facing the step 62 into the force sensor 80 and may be measured by the force sensor 80. A sensor signal of the force sensor 80 is supplied by means of a flexible printed conductor, which is not shown in FIG. 2A, to open- and closed-loop control circuits. The flexible printed conductor extends through a bore 82 formed in the housing 60.

The planar force sensor 80 is a piezoelectric sensor. More precisely, the force sensor 80 comprises a planar substrate of borosilicate glass, on which a monocrystalline piezoresistive layer has been fixed by means of a conventional bonding technique. The piezoresistive layer was deposited by means of an epitaxial technique and configured by means of a reactive ion etching step (FIG. 4).

FIGS. 2B and 2C illustrate further embodiments relating to the arrangement of a force sensor 80. In the embodiment according to FIG. 2B the force sensor 80 is integrated, not into the housing 60 of the disc brake, but into the mounting 76, i.e. into a component of the bearing 64. As FIG. 2B reveals, the force sensor 80 is disposed at an end face of the mounting 76 facing the end face 66 of the housing 60.

According to the embodiment illustrated in FIG. 2C, a separate carrier ring 84 is provided for the force sensor or sensors 80. The carrier ring 84 is disposed as a separate component between the step 62 of the housing 60 and the mounting 76 of the bearing 64. For this purpose, a further step 86 for receiving the carrier ring 84 is formed in the end face 66 of the step 62.

FIG. 3 shows a plan view of the end face 66 of the step 62 with the carrier ring 84 of FIG. 2C. The plan view corresponds to a view into the opening 58 of the housing 60 according to FIG. 1 along the arrow B prior to assembly of the bearing 64 and the conversion device 42. As FIG. 3 reveals, altogether four force sensors 80, 80′, 80″, 80′″ are fastened to the carrier ring 84 in such a way that two force sensors adjacent in peripheral direction of the carrier ring 84 have in relation to the longitudinal axis A an angular distance of exactly 90°. Such an arrangement of the force sensors 80, 80′, 80″, 80′″, even in the event of non-symmetrical loading of the step 62 acting as a support device with the reaction force, guarantees a reliable determination of the actual clamping force, e.g. by taking the mean of the four resulting sensor signals. As FIG. 3 reveals, the individual force sensors 80, 80′, 80″, 80′″ are disposed at a distance from one another in a plane at right angles to the longitudinal axis A.

FIG. 4 shows a detail IV of the view according to FIG. 3. From FIG. 4 it is possible to see, in particular, the construction of a single one of the four force sensors 80, 80′, 80″, 80′″ illustrated in FIG. 3. The force sensor 80′″ comprises a planar substrate 92 and a piezoresistive layer 90, which is configured in the manner of a bridge and disposed on the substrate 92. By means of the bridge structure of the piezoresistive layer 90 temperature effects may be compensated.

The previously described floating-caliper disc brake allows an exact conclusion to be reached about the clamping force for the purpose of controlling an electromotive vehicle brake system and in particular takes into account a non-symmetrical action of force upon the support device. The use of planar force sensors is advantageous in terms of the structural design and, in particular, the overall size of the disc brake. It is moreover advantageous that the individual force sensors are disposed at a distance from the brake shoes and therefore outside of regions of high temperatures.

1. Disc brake (10), comprising
two brake shoes (16, 18), which for generating a clamping force (B, B′) are pressable against both sides of a brake disc (20);
a conversion device (42), which is connectable to a motor (30) and which converts a driving motion of the motor (30) into an actuating motion for actuating at least one of the brake shoes (16, 18); and
a support device (62) for taking up a reaction force (C), which upon generation of the clamping force (B, B′) is introduced into the conversion device (42), characterized in
that between the conversion device (42) and the support device (62) at least one force sensor is disposed for measuring at least a fraction of the reaction force (C).

2. Disc brake according to claim 1, characterized in that the at least one force sensor (80) has a planar form of construction.

3. Disc brake according to claim 1 or 2, characterized in that the at least one force sensor (80) is a piezoelectric sensor.

4. Disc brake according to one of claims 1 to 3, characterized in that the at least one force sensor (80) has a piezoresistive layer (90) applied onto a planar substrate (92).

5. Disc brake according to one of claims 1 to 4, characterized in that the disc brake (10) comprises two or more force sensors (80, 80′, 80″, 80′″), which are disposed at a distance from one another in a plane at right angles to a longitudinal axis (A) of the disc brake (10).

6. Disc brake according to one of claims 1 to 5, characterized in that the disc brake (10) comprises four or more force sensors (80, 80′, 80″, 80′″), wherein each two adjacent force sensors (80, 80′, 80″, 80′″) have an angular distance in the order of magnitude of 90° or less in relation to the longitudinal axis (A) of the disc brake (10).

7. Disc brake according to one of claims 1 to 6, characterized in that the support device (62) is coupled rigidly to a housing (60) of the disc brake (10).

8. Disc brake according to claim 7, characterized in that the support device comprises a step (62) formed in the housing (60) of the disc brake (10).

9. Disc brake according to claim 8, characterized in that the at least one force sensor (80) is applied onto the step (62) or integrated at least partially into the step (62).

10. Disc brake according to one of claims 1 to 8, characterized in that between the conversion device (42) and the support device (62) a carrier (84) is disposed for receiving the at least one force sensor (80).

11. Disc brake according to one of claims 1 to 8, characterized in that between the conversion device (42) and the support device (62) a bearing (64) is disposed and the at least one force sensor (80) is fastened in or on a component (76) of the bearing (64).

12. Disc brake according to one of claims 1 to 11, characterized in that the conversion device (42) converts a rotary driving motion of the motor (30) into a translatory actuating motion for actuating at least one of the brake shoes (16, 18).

13. Disc brake according to claim 12, characterized in that the support device (62) interacts with a component (46) of the conversion device (42), which component is settable in rotational motion.

14. Disc brake according to claim 12 or 13, characterized in that the conversion device (42) comprises a nut/spindle arrangement (44, 46, 50).

15. Disc brake according to claim 14, characterized in that the spindle (46) is settable in rotational motion and supported relative to the reaction force (C) against the step (60).

16. Vehicle brake system having a disc brake (10) according to one of claims 1 to 16.
